(19) United States
(12) Patent Application Publication
(10) Pub. No.: US 2010/0241548 A1
(43) Pub. Date: Sep. 23, 2010

(54) Method for Providing Access to Funds for Small and Medium Sized Enterprises

(76) Inventors: Vikramaditya Mathur, New Delhi (IN); Soumitra Sharma, New Delhi (IN)

Correspondence Address: JAY M. SCHLOFF, 6960 Orchard Lake Road, Suite 315, West Bloomfield, MI, 48322, US

(21) Appl. No.: 12/424,137

(22) Filed: Apr. 15, 2009

(30) Foreign Application Priority Data
Mar. 20, 2009 (IN) 534/DEL/2009

(51) Int. Cl. G06Q 40/00

(52) U.S. Cl. 705/35

(57) ABSTRACT

Disclosed is a method for providing access to funds to at least one Small and Medium sized Enterprise (SME) of a plurality of SMEs. Each SME is associated with at least one enterprise sector. One or more fund requests are received for obtaining the funds from a corpus of funds. Each fund request of the one or more fund requests is associated with an SME of the plurality of SMEs. The corpus of funds includes investments from a plurality of investors. The plurality of investors includes public entities and private entities. Further, the one or more fund requests are reviewed based on a pre-defined framework. Furthermore, the at least one SME of SMEs associated with the one or more fund requests is shortlisted based on the review. An SME of the shortlisted SMEs is provided access to a fund from the corpus of funds.

### CROSS-REFERENCE TO RELATED APPLICATIONS

The present application claims priority under the Paris Convention and under 35 U.S.C. § 119 to Indian Patent Application No. 534/DEL/2009, filed on Mar. 20, 2009, the contents of which are incorporated herein by reference in their entirety.

### FIELD OF THE INVENTION

The present invention generally relates to funding of enterprises, and, more particularly, to a method for providing access to funds for Small and Medium sized Enterprises (SMEs).

### BACKGROUND OF THE INVENTION

Enterprises, typically, specialize in one or more enterprise sectors. Examples of enterprise sectors may include Information Technology (IT) sector, textile sector, agriculture sector, automotive sector, and the like. Each enterprise sector typically includes enterprises of various sizes with regard to headcount, annual turnover, investments in plant and machinery, and assets. Enterprises with annual turnover, headcount, investments in plant and machinery, and/or assets below a threshold value, are referred to as Small and Medium sized Enterprises (SMEs). The SMEs typically require funds at regular intervals to meet growth requirements.

An SME may typically borrow funds to finance the growth requirements. Such form of fund acquisition is referred to as debt financing and the SME may approach financial institutions, such as banks, for acquiring the funds. Alternatively, the SME may opt for equity financing and may exchange equity (or a share) in the SME for funds. The SME may typically approach investors, such as venture capitalists and angel investors, for the funds in exchange of equity in the SME.

For the SMEs belonging to high-growth sectors, such as IT sector, acquiring the funds using at least one of debt financing and equity financing may be less cumbersome than for the SMEs belonging to low-growth and high-risk sectors, such as agriculture sector and leather sector. The investors may typically choose to purchase equity from the SMEs belonging to high-growth sectors rather than from the SMEs belonging to the low-growth and high-risk sectors. Acquiring the funds, especially using equity financing, may be cumbersome for the SMEs belonging to the low-growth and high-risk sectors, which may inhibit development of such SMEs.

Further, the SMEs belonging to the low-growth and high-risk sectors may be located at remote locations and as such may not be aware of investors, typically residing in financial and business centers, willing to invest in such SMEs. The investors may need to incur high costs for locating suitable SMEs for provisioning the funds, thereby adding to transaction costs. The investors may also be wary of investing in such SMEs, especially at an early stage of development of the SMEs, as investing in these SMEs is inherently risky.

Accordingly, there exists a need for providing access to funds for SMEs. There also exists a need to provision funds for the SMEs at any stage of development of the SMEs. Further, there exists a need for attracting investors to provide funds for SMEs belonging to a variety of enterprise sectors to ensure adequate percolation of the funds across the business sectors. Still further, there exists a need to create awareness among SMEs about investors interested in providing equity financing for various enterprise sectors. Furthermore, there exists a need to diversify risk for the investors and reduce costs for the investors for locating suitable SMEs for provisioning the funds.

### SUMMARY OF THE INVENTION

In view of the foregoing disadvantages inherent in the prior art, the general purpose of the present invention is to provide a method for providing access to funds for Small and Medium sized Enterprises (SMEs), that is configured to include all advantages of the prior art, and to overcome the drawbacks inherent therein.

Therefore, an object of the present invention is to provide access to funds to SMEs from various enterprise sectors.

Another object of the present invention is to diversify risks involved in investing in SMEs.

Yet another object of the present invention is to attract investors to provide funds for SMEs.

Still another object of the present invention is to create awareness among SMEs about equity financing options.

Yet another object of the present invention is to reduce costs incurred by investors in locating SMEs.

Still another object of the present invention is to provide access to funds for SMEs at various stages of development of the SMEs.

In an aspect of the present invention, a method is disclosed for providing access to funds to at least one SME of a plurality of SMEs. Each SME of the plurality of SMEs is associated with at least one enterprise sector. One or more fund requests are received for obtaining the funds from a corpus of funds. Each fund request of the one or more fund requests is associated with an SME of the plurality of SMEs. The corpus of funds includes investments from a plurality of investors. Each investor of the plurality of investors is at least one of a public entity and a private entity. The one or more fund requests are reviewed based on a pre-defined framework. The at least one SME of SMEs associated with the one or more fund requests is shortlisted based on the review of the one or more fund requests. An SME of the shortlisted at least one SME is provided access to a fund from the corpus of funds.

Pooling funds in a corpus permits investors to diversify risks that are involved in investing in certain SMEs. Further, the method also includes disseminating information of the corpus of funds to the plurality of SMEs for receiving the one or more fund requests. The dissemination of the information creates awareness about equity financing options among the plurality of SMEs of the corpus of funds, thereby attracting the plurality of SMEs to submit their fund requests. The plurality of SMEs submitting their fund requests precludes the need for the investors to incur substantial costs in identifying suitable SMEs for providing funds.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a flow diagram representing a method for providing access to funds to at least one Small and Medium sized Enterprise (SME) of a plurality of SMEs, in accordance with an embodiment of the present invention;

FIG. 2 is a flow diagram representing a method for providing access to funds to at least one SME of the plurality of SMEs, in accordance with another embodiment of the present invention; and

FIG. 3 depicts a block diagram depicting interaction among a plurality of stakeholders and a plurality of SMEs, in accordance with an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced items.

The present invention discloses a method for providing access to funds to at least one Small and Medium sized Enterprise (SME) of a plurality of SMEs. Each SME of the plurality of SMEs is associated with at least one enterprise sector. One or more fund requests are received for obtaining the funds from a corpus of funds. Each fund request of the one or more fund requests is associated with an SME of the plurality of SMEs. The corpus of funds includes investments from a plurality of investors. Each investor of the plurality of investors is at least one of a public entity and a private entity. The one or more fund requests are reviewed based on a pre-defined framework. The at least one SME of SMEs associated with the one or more fund requests is shortlisted based on the review of the one or more fund requests. An SME of the shortlisted at least one SME is provided access to a fund from the corpus of funds.

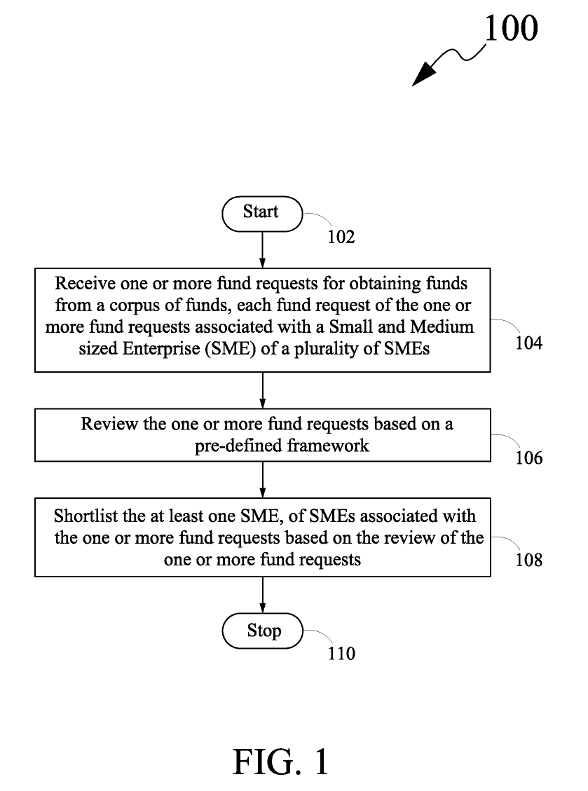

FIG. 1 is a flow diagram representing a method 100 for providing access to funds to at least one SME of a plurality of SMEs, in accordance with an embodiment of the present invention. The method 100 begins at 102. At 104, one or more fund requests for obtaining funds from a corpus of funds are received. Each fund request of the one or more fund requests is associated with an SME of the plurality of SMEs. The corpus of funds includes investments from a plurality of investors. Each investor of the plurality of investors is at least one of a public entity and a private entity. More specifically, the each investor may be a public entity, a private entity, or an entity formed by a combination of public ownership and private ownership.

At 106, the one or more fund requests are reviewed based on a pre-defined framework. At 108, the at least one SME of SMEs associated with the one or more fund requests is shortlisted based on the review of the one or more fund requests. An SME of the shortlisted at least one SME is provided access to a fund from the corpus of funds. The access to the fund represents equity financing that is provided to the SME for assisting in growth of the SME. At 110, the method 100 ends.

For the purpose of description of the present invention, an SME may be defined based on a geographical region and the enterprise sector of the SME. For example, in Indian context, a service sector enterprise with annual turnover between Indian Rupees (INR) 10 lakh and INR five crore may be categorized as a micro, small or medium sized enterprise. In another example, a manufacturing sector enterprise with the annual turnover between INR 25 lakh and INR 10 crore may be categorized as a micro, small or medium sized enterprise. Alternatively, in another geographical region, such as the United States of America (USA), an SME may be defined based on a North American Industry Classification System (NAICS) code of the enterprise sector of the SME.

For example, the NAICS code 112340 for a poultry hatchery enterprise sector may define an SME as an enterprise with annual revenues of up to USD 0.75 million. In another example, the NAICS code 316211 for a rubber and plastics footwear enterprise sector may define an SME as an enterprise with number of employees up to 1000. It will be evident to a person skilled in the art that definitions of SMEs may vary from one geographical region to another. More specifically, an enterprise may be defined as an SME in various ways, based on the geographical region, such as a state, a country and a continent, where the enterprise is located. It will be evident to a person skilled in the art that examples provided above are included for exemplary purposes only and any such values may be defined for classifying an enterprise as an SME.

It will be evident to those skilled in the art that the funds as described herein may be a supply of capital to be provided to the at least one SME of the plurality of SMEs. The corpus of funds may be created for a particular region to provide equity finance for the plurality of SMEs operating in the region. Examples of the region may include a district, a state, a country, and the like. Creation of the corpus of funds may be initiated by a stakeholder of a plurality of stakeholders. A stakeholder of the plurality of stakeholders may hold a stake in the corpus of funds.

An SME of the plurality of SMEs may provide a fund request to receive a fund from the corpus of funds. An advisor may be enabled to receive the fund request from the SME. Examples of the advisor include entities, such as financial advisors, business consultants, management consultants, advisory arms of banks, investment banks, and the like. In an embodiment, the SME may provide the fund request to a cluster consultant. The cluster consultant may receive fund requests from SMEs of the plurality of SMEs. The cluster consultant may perform an approval and rejection of the fund requests based on the review criteria. Thereafter, the cluster consultant may provide approved fund requests of the received fund requests to the advisor. Examples of the cluster consultant include Chartered Accountants (CAs), industry experts, on-the-ground consultants, business facilitators, transaction facilitators, industry cluster associations, intermediaries, and the like. It will be apparent to a person skilled in the art that a plurality of cluster consultants may exist for receiving the fund requests from the SMEs of the plurality of SMEs.

The advisor may review the fund request provided by the SME, based on the predefined framework. In an embodiment of the present invention, the predefined framework may include review criteria for reviewing the fund request received from the SME. A review criterion of the review criteria may include at least one of a geographical region of the SME, an availability of the funds for the enterprise sector of the SME, a size of the SME and a feasibility of the fund request. More specifically, a review criterion for the fund request provided by the SME may be the geographical region of the SME. Examples of the geographical region may include a country, a state, a district, a village, and the like. Further, the fund request may be reviewed based on the enterprise sector of the SME. An enterprise sector may be allocated a portion of the corpus of funds based on requirement of the enterprise sector. For example, a sum of USD 200 million of the corpus of funds may be reserved for agricultural sector. An SME ‘A’ from the agriculture sector may be allotted a fund of a particular amount from the corpus of funds if the required amount is available in the sum reserved for the agricultural sector.

Furthermore, the fund request by the SME may be reviewed based on the size of the SME. Still further, the fund request by the SME may be reviewed based on the feasibility of the fund request. For example, an SME ‘B’ may provide a fund request of USD 500,000. The feasibility of the fund request may be determined based on analysis of the fund request and a business plan associated with the fund request.

In an embodiment of the present invention, the fund request may be received by the cluster consultant. The cluster consultant may review the fund request based on the review criteria as explained above. The cluster consultant may approve an SME based on the review of the fund request received from the SME. The fund request of the approved SME may be provided to the advisor for the review. As explained, the advisor may receive the one or more fund requests directly from SMEs or via the cluster consultants. The advisor may review the one or more fund requests received from SMEs of the plurality of SMEs.

The advisor may shortlist the at least one SME of the SMEs associated with the one or more fund requests, based on the review of the one or more fund requests. Thereafter, fund requests of the shortlisted at least one SME may be provided to a governing body that is enabled to manage the corpus of funds. Further, the governing body may review the fund requests of the shortlisted SMEs. The governing body may approve the fund request of at least one SME of the shortlisted SMEs. SMEs associated with approved fund requests may be provided funds from the corpus of funds by the governing body.

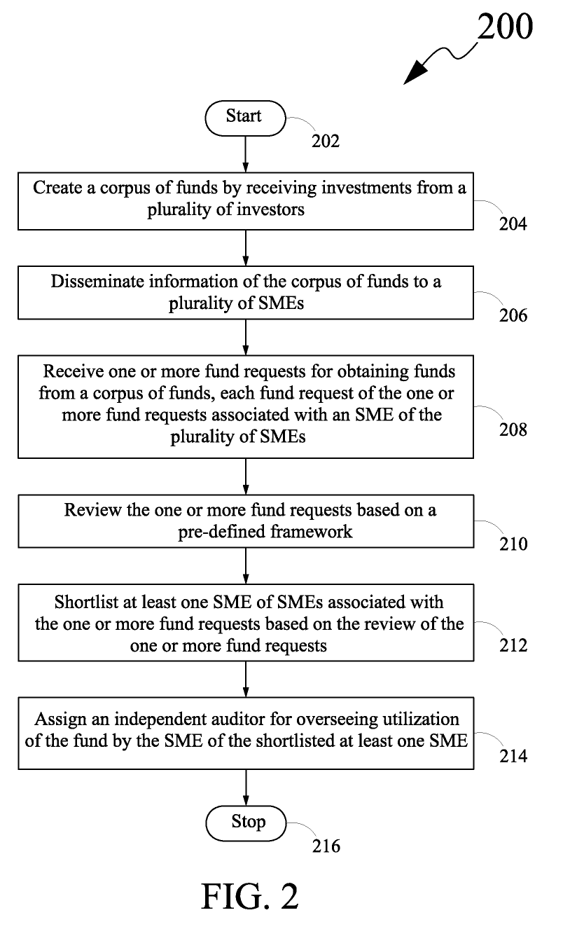

In an embodiment of the present invention, the governing body may utilize a part of the corpus of funds for operating the corpus of funds. In another embodiment of the present invention, the advisor may receive remuneration when a fund request of an SME sent by the advisor is approved by the governing body. For example, the advisor may receive a remuneration of USD 1000 when a fund request of an SME ‘C’ is approved by the governing body. A more detailed method for providing access to funds to the plurality of SMEs is explained in conjunction with FIG. 2.

FIG. 2 is a flow diagram representing a method 200 for providing access to the funds to the at least one SME, in accordance with another embodiment of the present invention. The method 200 begins at 202. At 204, the corpus of funds is created by receiving investments from the plurality of investors. The creation of the corpus of funds may be initiated by an advisor. The advisor may approach private entities, such as venture capitalists, angel investors, Private Equity (PE) funds and High Networth Individuals (HNI's), and public entities, such as Ministry of Company Affairs, Small Industries Development Bank of India (SIDBI) and Ministry of Micro Small and Medium Enterprises (MSME) in the Indian context; and Small Business Administration (SBA), Office of Small and Disadvantaged Business Utilization (OSDBU), Economic Development Loan Fund (EDLF), and the like, in the US context, to facilitate the creation of the corpus of funds.

At 206, information of the corpus of funds may be disseminated to the plurality of SMEs for receiving the one or more fund requests. The information of the corpus of funds may be disseminated through the advisor. It will be apparent to a person skilled in the art that disseminating the information of the corpus of funds represents creating awareness of the corpus of funds among the plurality of SMEs. In an embodiment of the present invention, the information may be disseminated online, through a website that may be maintained by a stakeholder of the plurality of stakeholders, such as Ministry of Company Affairs, Small Industries Development Bank of India (SIDBI), Ministry of Micro Small and Medium Enterprises (MSME), and the like. Further, the information of the corpus of funds may be disseminated through print media and electronic media. Still further, the information of the corpus of funds may be disseminated by engaging programs or organizations, such as Project Vikas, SME programs run by the United Nations, and the like. Furthermore, the information of the corpus of funds may be disseminated through industry champions, national level associations, and other similar networked organizations.

At 208, the one or more fund requests are received for obtaining funds from the corpus of funds. Each fund request of the one or more fund requests is associated with an SME of the plurality of SMEs. As explained previously, the corpus of funds includes investments from the plurality of investors. Further, each investor of the plurality of investors may be at least one of a public entity and a private entity. As explained previously, the each investor may either be a public entity, a private entity or an entity formed by a combination of public ownership and private ownership. The one or more fund requests for obtaining funds from the corpus of funds may be received by an advisor. The advisor may receive the one or more fund requests from a cluster consultant and/or directly from SMEs of the plurality of SMEs. The cluster consultant may receive fund requests of the one or more fund requests from SMEs of the plurality of SMEs. The cluster consultant may review the fund requests based on the review criteria. Further, the cluster consultant may send an approved list of SMEs to the advisor for review.

At 210, the one or more fund requests are reviewed by the advisor based on the pre-defined framework, as explained in conjunction with the method 100 of FIG. 1. The one or more fund requests may be reviewed by the advisor based on the review criteria for reviewing the one or more fund requests. At 212, the advisor may shortlist at least one SME of SMEs associated with the one or more fund requests based on the review of the one or more fund requests. An SME of the shortlisted SMEs is provided access to a fund from the corpus of funds. The SME may be provided the fund on an approval of a fund request associated with the SME by a governing body that is enabled to distribute funds from the corpus of funds.

At 214, an independent auditor may be assigned for overseeing allocation of the fund to the SME of the shortlisted SMEs. More specifically, the auditor may be a public entity or a private entity that may be enabled to examine accounting records, and verify balance sheets and income items of the corpus of funds. Further, the auditor may be assigned for auditing financials of the corpus of funds (including verifying incoming and outgoing cash flows) and periodically reporting financial movements and status of the corpus of funds to the plurality of investors.

In an embodiment of the present invention, a portion of the fund provided for the SME is reserved for the advisor that shortlisted the SME. The advisor is provisioned the portion of the fund for advisory services, such as reviewing the fund request of the SME. At 216, the method 200 ends.

It will be apparent to a person skilled in the art that the method 100 and the method 200 may be performed by the advisor.

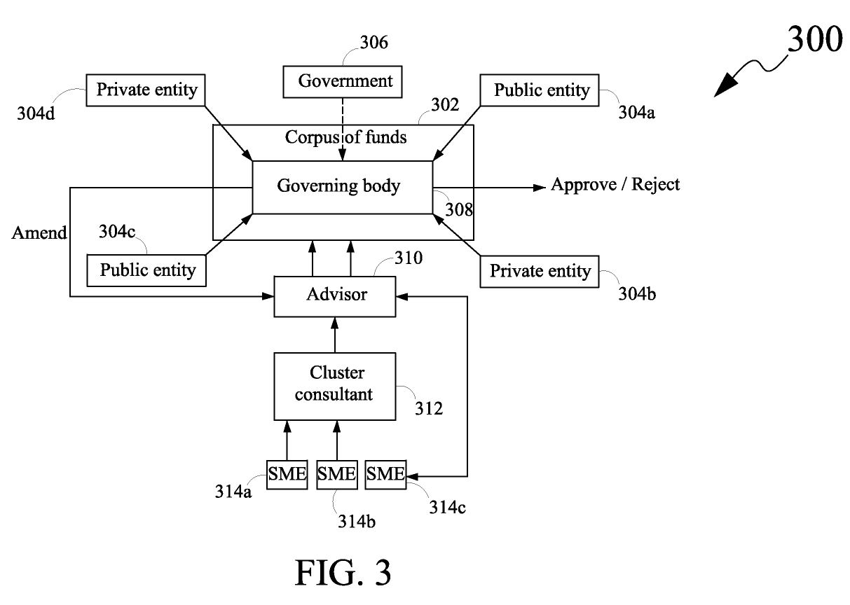

FIG. 3 illustrates a block diagram 300 depicting an interaction among a plurality of stakeholders and a plurality of SMEs, in accordance with an embodiment of the present invention. The block diagram 300 depicts a corpus of funds 302, a plurality of investors, such as a public entity 304a, a private entity 304b, a public entity 304c and a private entity 304d, a government 306, a governing body 308, a plurality of advisors, such as an advisor 310, a plurality of cluster consultants, such as a cluster consultant 312, and a plurality of Small and Medium Sized Enterprises (SMEs), such as an SME 314a, an SME 314b and an SME 314c. It will be apparent to a person skilled in the art that the block diagram 300 is depicted for exemplary purposes and that any such arrangement may be envisioned for providing funds to SMEs of the plurality of SMEs.

The corpus of funds 302 includes investments from the plurality of investors. An investor of the plurality of investors may be at least one of a public entity, such as the public entity 304a and 304c, and a private entity, such as the private entity 304b and 304d. The plurality of investors will hereinafter collectively be referred to as ‘plurality of investors 304a-d’. Examples of the plurality of investors 304a-d include, but are not limited to, government agencies, public sector banks, private banks, investment banks, Private Equity (PE) funds, multilateral agencies, insurance firms, venture capitalists, fund of funds and pension funds.

The government 306 may also invest in the corpus of funds 302. More specifically, the government 306 may invest directly or indirectly in the corpus of funds 302. The government 306 may provide a direct investment to the corpus of funds 302. For example, the government 306 may invest USD 400 million in the corpus of funds. In case of the direct investment, the government 306 may receive direct returns on the direct investment being a direct equity investor in the SMEs that are provided the equity financing by the corpus of funds 302. Accordingly, the government 306 may receive the direct returns on the direct investment as is received by other investors of the plurality of investors 304a-d. Alternatively, the government 306 may provide tax and regulatory benefits to the plurality of investors 304a-d investing in the corpus of funds 302, thereby investing indirectly in the corpus of funds 302. In case of indirect investment, the government 306 may receive a one time joining fee and/or a yearly membership fee from the plurality of investors 304a-d, thus receiving indirect returns from the indirect investment in the corpus of funds 302. By way of the direct investment and/or the indirect investment and consequently receiving the direct returns and/or the indirect returns, the government 306 shares the risks and returns involved in investing in the corpus of funds 302 with the plurality of investors 304a-d. These direct and/or indirect investments in the corpus of funds 302, and consequent sharing of the risks and the returns by the plurality of investors 304a-d and the government 306, form a public private partnership between the plurality of investors 304a-d and the government 306. The corpus of funds 302 may be managed jointly by the plurality of investors 304a-d and the government 306.

More specifically, the corpus of funds 302 may be associated with a plurality of stakeholders. Each of the plurality of stakeholders may hold a stake in the corpus of funds 302. Examples of a stakeholder of the plurality of stakeholders include the plurality of investors 304a-d, the government 306, the plurality of advisors and the plurality of cluster consultants. The corpus of funds 302 may be managed by the plurality of stakeholders. More specifically, at least one stakeholder of the plurality of stakeholders may represent the governing body 308 for managing the corpus of funds 302. The governing body 308 may be elected or nominated by the plurality of stakeholders. The governing body 308 may approve funds to be provided to SMEs of the plurality of SMEs. The governing body 308 may receive fund requests of shortlisted SMEs of the plurality of SMEs from the advisor. The governing body 308 may approve or reject the fund requests of the shortlisted SMEs. SMEs associated with the approved fund requests may be provided the funds from the corpus of funds 302. Further, the governing body 308 may require certain fund requests to be amended. These fund requests and associated SMEs may be redirected to an advisor, such as the advisor 310, for assisting the SMEs in amending the fund requests.

Further, the plurality of advisors and the plurality of cluster consultants may receive the fund requests from the plurality of SMEs. The plurality of advisors and the plurality of cluster consultants may shortlist SMEs of the plurality of SMEs based on review of the fund requests. Further, the fund requests approved by the cluster consultant 312 may be redirected to the advisor 310 for an approval. Thereafter, fund requests approved by the advisor 310 may be redirected to the governing body 308 for approval or rejection.

As explained previously, the corpus of funds 302 is associated with the plurality of stakeholders. Each of the plurality of stakeholders may hold a stake in the corpus of funds 302. In an embodiment of the present invention, each stakeholder of the plurality of stakeholders may be associated with a role. More specifically, each of the plurality of investors 304a-d, the advisor 310, the plurality of cluster consultants, such as the cluster consultant 312 and the government 306 may be associated with a role. An investor, such as the public entity 304a, of the plurality of investors 304a-d may be associated with an investor role. By definition, an investor is a public entity or a private entity who has invested in the corpus of funds 302. The investor role involves acquiring an equity stake in the SMEs that have been provided funds by the governing body 308.

Further, the investor role may enable the plurality of investors, such as the public entity 304a or the private entity 304b, to receive tax and regulatory benefits from the government 306. Furthermore, the investor role requires the plurality of investors 304a-d to operate as a consortium. Still further, the investor role may include utilizing marketing networks to perform marketing activities, such as road shows, to generate awareness of the corpus of funds among the plurality of SMEs.

Similarly, the government 306 may be associated with a government role. The government role may involve facilitating creation of the corpus of funds 302. For the same purpose, the government 306 may create a program for assisting the plurality of SMEs in receiving equity financing. The program may attract the plurality of investors 304a-d to invest in the corpus of funds 302. Further, the government 306 may be enabled to provide the tax and regulatory benefits to the plurality of investors 304a-d. As mentioned earlier, in an embodiment of the present invention, the government 306 may be enabled to receive a one-time joining fee and/or a subsequent yearly membership fee from each investor of the plurality of investors. Further, the government role may involve marketing and creating awareness of the corpus of funds 302 among the plurality of SMEs. For this purpose, the government 306 may engage government resources, such as local institutions and officials to initiate awareness generation programs.

Still further, the government role may enable the government 306 to operate as a regulator for the corpus of funds 302, thereby safeguarding interests of the plurality of investors 304a-d and the SMEs that are provided the funds. Further, the government role may enable the government 306 to create an investment mandate for regulating utilization of the corpus of funds 302. The investment mandate may include regulations to ensure that access to funds from the corpus of funds 302 is facilitated for micro SMEs with low turnovers, for SMEs that are at various stages of development and for SMEs from specific sectors.

Similarly, the advisor 310 of the plurality of advisors may be associated with an advisor role. The advisor role may involve reviewing the one or more fund requests received from SMEs of the plurality of SMEs based on the review criteria. Further, the advisor role may involve overseeing utilization of the funds provided to the SMEs, based on covenants laid down for utilization of the corpus of funds 302. Furthermore, the advisor role may involve advising and mentoring an SME, such as the SME 314c, associated with a fund request. The advisor 310 may advise and mentor the SME 314c when the governing body 308 indicates amendments to the fund request provided by the SME 314c. The advisor 310 may be enabled by the advisor role to assist the SME 314c in amending the fund request for improving probability of being provided the fund by the governing body 308. In an embodiment of the present invention, the advisor may be enabled by the advisor role to assist an SME in creation of a fund request, thereby increasing probability of the fund request to be approved by the governing body 308. In another embodiment of the present invention, the advisor 310 may be enabled by the advisor role to facilitate creation of the corpus of funds 302.

Further, the advisor role may involve conducting capacity building programs, awareness generation seminars and programs for the plurality of stakeholders. The capacity building programs refer to training programs that may be directed to familiarize a stakeholder, such as a government official, an advisor, a cluster consultant, an investor, and the like, with functioning of the corpus of funds 302. Furthermore, the capacity building programs may facilitate the stakeholder to understand roles of other stakeholders. Still further, the advisor role may involve publishing of white papers to generate awareness among the plurality of stakeholders and the plurality of SMEs.

Accordingly, the cluster consultant 312 of the plurality of cluster consultants may be associated with a consultant role. The consultant role may involve operating as an interface between the corpus of funds 302 and the plurality of SMEs to enable SMEs from various geographical regions to provide fund requests for receiving equity finance. The cluster consultant 312 may be enabled to receive fund requests from one or more SMEs of the plurality of SMEs. The consultant role may enable the cluster consultant 312 to approve or reject the fund requests. Thereafter, the consultant role may enable the cluster consultant 312 to refer approved fund requests to the advisor 310. In an embodiment of the present invention, the cluster consultant may be provided incentives for submitting approved fund requests of SMEs to the advisor. In an embodiment of the present invention, the information of the corpus of funds 302 may be disseminated through at least one of the plurality of cluster consultants, such as the cluster consultant 312 and the plurality of investors 304a-d. Examples of the cluster consultant 312 include, but are not limited to, CAs, enterprise sector experts, business facilitators, industry cluster associations and intermediaries. It will be apparent to a person skilled in the art that roles associated with the plurality of stakeholders may be interchanged.

Providing access to funds to at least one Small and Medium sized Enterprise (SME) of a plurality of SMEs as implemented by methods, such as the method 100 and the method 200, of the present invention, is advantageous for development and growth of the at least one SME. The funds are provided from a corpus of funds managed by a Public Private Partnership (PPP) between a government and a plurality of investors. The existence of a PPP attracts investors to invest in the corpus of funds. The method involves participation by a plurality of investors in the corpus of funds, thereby enabling diversification of risk for the plurality of investors. Further, the method provisions tax and regulatory benefits for the plurality of investors, thereby attracting potential investors to invest in the corpus of funds. Furthermore, the method facilitates creation of awareness among the plurality of SMEs about investors providing equity financing, thereby attracting the plurality of SMEs to submit their fund requests. Moreover, government involvement as a facilitator ensures that SMEs of various sizes, turnovers and sectors are provided access to the funds of the corpus of funds. Further the government involvement as the facilitator also ensures access to funds for SMEs at various stages of development. Still further, transaction costs incurred by investors in locating suitable SMEs are reduced due to information dissemination of the corpus of funds by a plurality of stakeholders and/or by cluster consultants.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A method for providing access to funds to at least one Small and Medium sized Enterprise (SME) of a plurality of SMEs, each SME of the plurality of SMEs associated with at least one enterprise sector, the method comprising:
receiving one or more fund requests for obtaining the funds from a corpus of funds, each fund request of the one or more fund requests associated with an SME of the plurality of SMEs, wherein the corpus of funds comprises investments from a plurality of investors, each investor of the plurality of investors being at least one of a public entity and a private entity;
reviewing the one or more fund requests based on a pre-defined framework; and
shortlisting the at least one SME of SMEs associated with the one or more fund requests based on the review of the one or more fund requests, wherein an SME of the shortlisted at least one SME is provided access to a fund from the corpus of funds.

2. The method of claim 1, further comprising creating the corpus of funds by receiving the investments from the plurality of investors prior to receiving the one or more fund requests.

3. The method of claim 1, wherein the private entity comprises at least one of a bank, a multilateral agency, a venture capitalist, a Private Equity (PE) fund, an angel investor, a High Networth Individual (HNI), a fund of funds, a pension fund and an insurance firm.

4. The method of claim 1, further comprising disseminating information of the corpus of funds to the plurality of SMEs for receiving the one or more fund requests.

5. The method of claim 4, wherein the information of the corpus of funds is disseminated through at least one of chartered accountants, enterprise sector experts, business facilitators, transaction facilitators, intermediaries and the plurality of investors.

6. The method of claim 1, wherein the pre-defined framework comprises review criteria for reviewing a fund request of the one or more fund requests.

7. The method of claim 6, wherein a review criterion of the review criteria comprises at least one of a geographical region of an SME associated with the fund request, an availability of the funds for the enterprise sector of the SME associated with the fund request, a size of the SME associated with the fund request and a feasibility of the fund request.

8. The method of claim 1, further comprising assisting an SME of the plurality of SMEs in creation of a fund request.

9. The method of claim 1, further comprising assigning an independent auditor for overseeing allocation of the fund to the SME of the shortlisted at least one SME.

10. The method of claim 1, wherein the SME of the shortlisted at least one SME is provided the fund on an approval of a fund request associated with the SME by a governing body, the governing body enabled to manage the corpus of funds.
